(19) United States
(12) Patent Application Publication
(10) Pub. No.: US 2007/0206162 A1
(43) Pub. Date: Sep. 6, 2007

(54) OPTICAL PROJECTION APPARATUS

(75) Inventors: Wen-Hao Chang, Miao-Li County (TW); Wei-Jen Cheng, Miao-Li County (TW); Chun-Li Chen, Miao-Li County (TW)

Correspondence Address: J C PATENTS, INC., 4 VENTURE, SUITE 250, IRVINE, CA, 92618, US

(73) Assignee: CORETRONIC CORPORATION, Miao-Li County (TW)

(21) Appl. No.: 11/566,808

(22) Filed: Dec. 5, 2006

(30) Foreign Application Priority Data
Mar. 2, 2006 (TW) 95106966

(51) Int. Cl. G03B 21/20

(52) U.S. Cl. 353/85

(57) ABSTRACT

An optical projection apparatus comprising an illumination system, a light valve, an imaging system, a power supply circuit and a generator are provided. The illumination system with a color wheel is providing a light beam. The light valve is disposed on the transmitting path of the light beam for transforming the light beam into an image light beam. The imaging system is also disposed on the transmitting path of the image light beam. The power supply circuit is electrically connected to the illumination system and the light valve is connecting with an external power supply. The generator is electrically connected to the power supply circuit. The color wheel connected to the generator drives the generator to generate electric power. The electric power is transmitted to the power supply circuit and powers the optical projection apparatus. Consequently, overall power consumption of the optical projection apparatus is reduced.

### CROSS-REFERENCE TO RELATED APPLICATION

This application claims the priority benefit of Taiwan application serial no. 95106966, filed Mar. 2, 2006. All disclosure of the Taiwan application is incorporated herein by reference.

### BACKGROUND OF THE INVENTION

1. Field of the Invention

The present invention relates to an optical projection apparatus, and more particularly, to an optical projection apparatus having a lower power consumption.

2. Description of Related Art

With the rapid advance in optical projection techniques in recent years, optical projection apparatus capable of outputting high quality and high resolution images are massively produced and deployed. The conventional optical projection apparatus utilizes a power cable connected to an external power supply for receiving the power for operation thereof. However, when the optical projection apparatus is carried to an environment where an external power supply cannot be found or during the power outage in the external power supply, the optical projection apparatus can no longer operate. To resolve this problem, some of the optical projection apparatus have an additional storage battery installed therein. When an external power supply is unavailable or there is a sudden power outage in the external power supply, the storage battery can provide the power for driving the optical projection apparatus. Yet, no energy is saved through this method because the power storage battery has to be recharged by the external power supply.

### SUMMARY OF THE INVENTION

Accordingly, at least one objective of the present invention is to provide an optical projection apparatus capable of operating at a lower power consumption level.

To achieve these and other advantages and in accordance with the purpose of the invention, as embodied and broadly described herein, the invention provides an optical projection apparatus. The optical projection apparatus includes an illumination system, a light valve, an imaging system, a power supply circuit and a generator. The illumination system with a color wheel is suitable for providing a light beam. The light valve is disposed on the transmitting path of the light beam and is suitable for transforming the light beam into an image light beam. The imaging system is also disposed on the transmitting path of the image light beam to display an image onto a screen. The power supply circuit is electrically connected to the illumination system and the light valve and is suitable for connecting with an external power supply. The generator is electrically connected to the power supply circuit. The color wheel connected to the generator drives the generator to produce electric power.

The foregoing optical projection apparatus further includes a storage battery, the generator is electrically connected to the power supply circuit via the storage battery. Furthermore, the power supply circuit has, for example, a voltage transformer and a microprocessor. The microprocessor is used for adjusting the duty ratio between the external power supply and the generator, which supply power to the illumination system and the light valve.

In addition, the optical projection apparatus further includes an opto-electric converter electrically connected to the power supply circuit for converting stray light into electrical power. The opto-electric converter is electrically connected to the power supply circuit via the storage battery and the microprocessor is used to adjust the duty ratio between the external power supply, the opto-electric converter and the generator, which supply power to the illumination system and the light valve.

In the optical projection apparatus of the present invention, the rotation of the color wheel drives the generator to produce electric power and the power produced by the generator can be supplied to the optical projection device. Therefore, the power consumption of the optical projection apparatus is reduced. Furthermore, through the opto-electric converter, the stray light inside the projector is converted into a source of power for driving the optical projection apparatus to further reduce the power consumption of the optical projection apparatus.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing major components of an optical projection apparatus according to one embodiment of the present invention.

FIG. 2 is a block diagram showing major components of an optical projection apparatus according to another embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

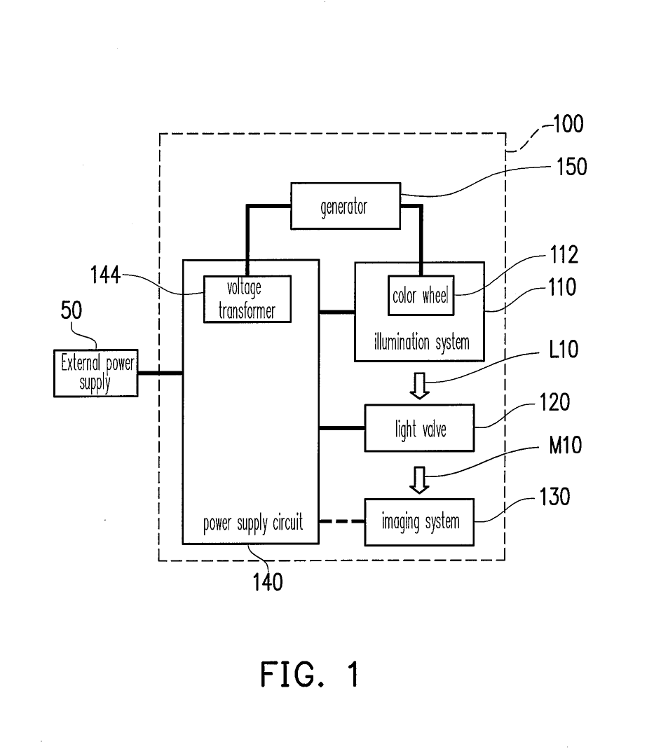

FIG. 1 is a block diagram showing major components of an optical projection apparatus according to one embodiment of the present invention. As shown in FIG. 1, the optical projection apparatus 100 in one embodiment according to the present invention includes an illumination system 110, a light valve 120, an imaging system 130, a power supply circuit 140 and a generator 150. The illumination system 110 is used for providing a light beam L10. The light valve 120 is disposed on the transmitting path of the light beam L10. The light valve 120 is suitable for converting the light beam L10 into an image light beam M10. The imaging system 130 is disposed on the transmitting path of the image light beam M10 to display an image onto a screen. The power supply circuit 140 is electrically connected to the illumination system 110 and the light valve 120 and is suitable for connecting with an external power supply 50 (for example, city electricity). Therefore, when the optical projection apparatus 100 operates, the power required by the illumination system 110 and the light valve 120 is obtained through the power supply circuit 140. The power supply circuit 140 has a voltage transformer 144 for transforming the voltage input to the power supply circuit 140 into a voltage suitable for driving the optical projection apparatus 100. In addition, when the imaging system 130 has an electromechanical-actuated focusing function, the power supply circuit 140 electrically connects to the imaging system 130 to provide the power needed to drive the focusing system. Conversely, when the imaging system 130 only has a manual focusing function, there is not always to electrically connect the power supply circuit 140 to the imaging system 130.

Inside the optical projection apparatus 100, the illumination system 110 has a color wheel 112. When the illumination system 110 operates, the color wheel 112 rotates continuously so that the light beam L10 passes through different areas of the color wheel 112 and the light beams L10 with different colors transmit to the light valve 120. In the meantime, the color wheel 112 is mechanically coupled to the generator 150 and the generator 150 is electrically connected to the power supply circuit 140. Thus, the rotation of the color wheel drives the generator 150 to produce electric power. Through the power transformer 144 of the power supply circuit 140, the voltage generated by the generator 150 is transformed into a voltage suitable for the illumination system 110 and the light valve 120. Thereafter, the voltage is supplied to the illumination system 110 and the light valve 120. In other words, due to the presence of the generator 150 in the optical projection apparatus 100, part of the rotational energy of the color wheel 112 is recycled and converted back to power required by the system. As a result, the demand of the optical projection apparatus 100 for power from the external power supply 50 is reduced and energy is conserved. Moreover, because the rotation of the color wheel 112 is stable and continuous when the optical projection apparatus operates, the generator 150 outputs continuous and steady electrical power.

Furthermore, aside from providing the power necessary for operating the optical projection apparatus 100, the power from the generator 150 feeds back to the external power supply (city electricity) after converting into alternating current (AC) through the voltage transformer 144 such as a DC-to-AC converter.

The optical projection apparatus 100 further includes a microprocessor (not shown) for adjusting the duty ratio between the external power supply 50 and the generator 150, which supply power to the illumination system 110 and the light valve 120. As a result, the loading of the power sources is more evenly distributed and the energy of the power sources is efficiently utilized.

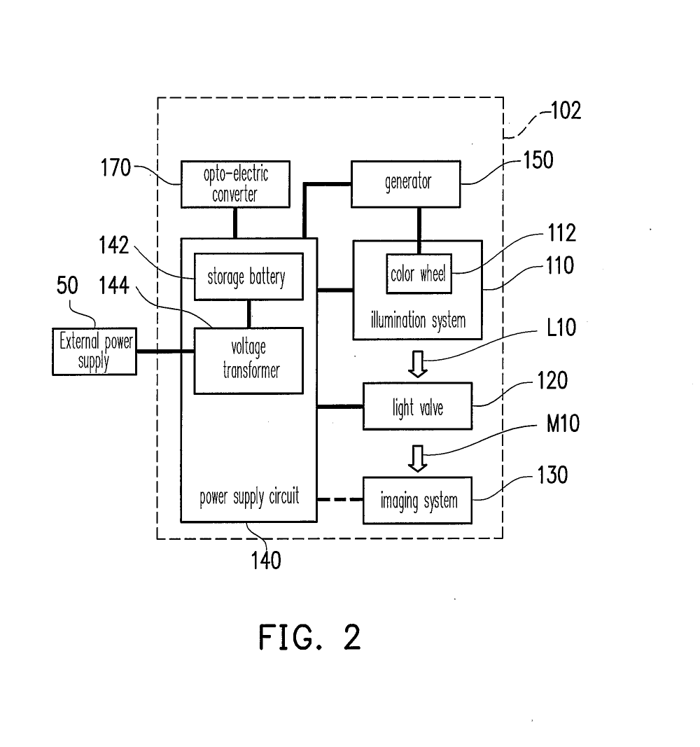

FIG. 2 is a block diagram showing major components of an optical projection apparatus according to another embodiment of the present invention. The optical projection apparatus 102 in the present embodiment is very similar to the optical projection apparatus 100 in FIG. 1. Hence, identical components are labeled identically and a description of the identical components is omitted. Beside the identical components, the optical projection apparatus 102 further includes an opto-electric converter 170 and the power supply circuit 140′ further includes a storage battery 142. The opto-electric converter 170 and the storage battery 142 are simultaneous disposed or independently disposed inside the optical projection apparatus 102. The opto-electric converter 170 is electrically connected to the power supply circuit 140′. Furthermore, the opto-electric converter 170 is, for example, a solar panel or other type of opto-electric converter. The opto-electric converter 170 is able to recover stray light inside the optical projection apparatus 102, convert the collected light energy into electrical energy and transfer the electrical energy to the power supply circuit 140′. Therefore, the opto-electric converter 170 similarly reduces the power consumption of the optical projection apparatus 102 from the external power supply 50. Moreover, because the diffuse light inside an operating optical projection apparatus 102 is rather stable, the opto-electric converter 170 is able to output continuous and steady electrical power.

In addition, the storage battery 142 is electrically connected to the opto-electric converter 170 and the generator 150 so that the electric power produced by the opto-electric converter 170 and the generator 150 is stored in the storage battery 142. Through the storage battery 142, the electric power needed to operate the optical projection apparatus 102 is provided when the external power supply 50 is interrupted or when no external power supply 50 is available. In the meantime, the storage battery 142 is recharged through the generator 150 and the opto-electric converter 170 so that there is no additional loading on the external power supply 50. Furthermore, the electric potential produced by the opto-electric converter 170 and the generator 150 is converted back into alternating current through the voltage transformer 144 such as a DC-to-AC converter and fed back to the external power supply (city electricity).

In addition, the optical projection apparatus 102 further includes a microprocessor (not shown) for adjusting the duty ratio between the outer power supply 50, the generator 150 and the opto-electric converter 170, which supply power to the illumination system 110 and the light valve 120. In this way, the power sources are able to provide an even power distribution and improve energy utilization. Furthermore, the microprocessor is also used to detect the output voltage of the storage battery 142 and adjust the output voltage of the voltage transformer 144 accordingly.

In summary, the optical projection apparatus in the present invention has a generator coupled to a color wheel so that some of the kinetic energy of the color wheel can be converted into electrical power that supports system loads. Moreover, an opto-electric converter inside the optical projection apparatus may be used to recover photonic energy and convert it into electrical power for supporting the system loads. Also, setting up a storage battery inside the optical projection apparatus is able to resolve the problem of power outage or the problem of having no external power source. In other words, the optical projection apparatus in the present invention has energy re-absorption and conversion capability so that power consumption is reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical projection apparatus, comprising:
an illumination system, suitable for providing a light beam, wherein the illumination system has a color wheel;
a light valve, disposed on a transmitting path of the light beam, wherein the light valve is suitable for converting the light beam into an image light beam;
an imaging system, disposed on a transmitting path of the image light beam;
a power supply circuit, electrically connected to the illumination system and the light valve, wherein the power supply circuit is suitable for connecting to an external power supply; and
a generator, electrically connected to a power supply circuit, wherein the color wheel connected to the generator drives the generator to produce electric power.

2. The optical projection apparatus of claim 1, further comprises an opto-electric converter electrically connected to the power supply circuit for converting stray light inside the optical projection apparatus into electrical power.

3. The optical projection apparatus of claim 2, wherein the power supply circuit further comprises a storage battery electrically connected to the opto-electric converter for storing up power produced by the opto-electric converter.

4. The optical projection apparatus of claim 2, further comprises a microprocessor for adjusting the duty ratio between the external power supply, the opto-electric converter and the generator supplying power to the illumination system and the light valve.

5. The optical projection apparatus of claim 1, wherein the power supply circuit further comprises a storage battery electrically connected to the generator for storing the power produced by the generator.

6. The optical projection apparatus of claim 1, wherein the power supply circuit has a voltage transformer for converting the voltage output of the power supply circuit into a voltage suitable for driving the optical projection apparatus.

7. The optical projection apparatus of claim 1, further comprises a microprocessor for adjusting the duty ratio between the external power supply and the generator, which supply power to the illumination system and the light valve.

8. The optical projection apparatus of claim 1, wherein the power supply circuit has a voltage transformer for converting the power input to the power supply circuit into an alternating current and feeding back the alternating current to the external power supply.
